(19) United States
(12) Patent Application Publication
(10) Pub. No.: US 2025/0052293 A1
(43) Pub. Date: Feb. 13, 2025

(54) ELASTIC SUPPORT MEMBER, AND SUSPENSION DEVICE

(71) Applicants: Hitachi Astemo, Ltd., Hitachinaka-shi (JP); HONDA MOTOR CO., LTD., Tokyo (JP)

(72) Inventors: Takahiro MASUDA, Hitachinaka-shi (JP); Ryo SAKAKIBARA, Hitachinaka-shi (JP); Masaki TAKENAKA, Hitachinaka-shi (JP); Tomoaki KUBOTA, Tokyo (JP)

(73) Assignees: Hitachi Astemo, Ltd., Hitachinaka-shi (JP); HONDA MOTOR CO., LTD., Tokyo (JP)

(21) Appl. No.: 18/799,607

(22) Filed: Aug. 9, 2024

(30) Foreign Application Priority Data
Aug. 10, 2023 (JP) 2023-131619

(51) Int. Cl. F16F 1/12; B60G 11/16

(52) U.S. Cl. CPC F16F 1/12; B60G 11/16

(57) ABSTRACT

An elastic support member interposed between a coil spring and a spring support member supporting an end of the coil spring includes a protrusion protruding from an opposing surface of the elastic support member facing the spring support member and configured to be inserted into a through-hole of the spring support member. The protrusion includes: a base sized, in a direction parallel to the opposing surface, to be smaller than the through-hole and configured to be fitted in the through-hole; and a lug protruding outward from an outer periphery of the base and located opposite the opposing surface with respect to the spring support member when the base is fitted in the through-hole. The lug includes a recess between it and the base depressed away from the opposing surface.

### CROSS REFERENCE TO RELATED APPLICATIONS

This application claims the benefit of priority under 35 U.S.C. § 119 to Japanese Patent Application No. 2023-131619 filed on Aug. 10, 2023, the content of which is incorporated herein by reference in its entirety.

### FIELD OF THE INVENTION

The present invention relates to an elastic support member and a suspension device.

### BACKGROUND OF THE INVENTION

For example, an elastic support member disclosed in JP2021-046910A includes a rubber body including a spring support surface to support an end coil of a coil spring. The rubber body is integrally formed with two fitting protrusions on its lower surface opposite the spring support surface. The fitting protrusions are configured to fit into respective through-holes formed in a spring seat. Each fitting protrusion includes a column portion adjacent to the rubber body and a fitting portion remote from the rubber body and fitting into the corresponding through-hole of the spring seat. The column portion has a diameter equal to or slightly smaller than the diameter of the through-hole of the spring seat and has a height slightly larger than the thickness of the spring seat. The fitting portion has a conical or conical trapezoidal shape with a downwardly reducing diameter and is larger than the diameter of the through-hole of the spring seat at the proximal end and smaller than the diameter of the through-hole at the distal end. The fitting protrusion fits into the corresponding through-hole of the spring seat as the annular shoulder surface formed at the upper end of the fitting portion engages the lower surface of the spring seat.

For the elastic support member disclosed in the above patent document, the insertion load on the fitting portion of the fitting protrusion when it is inserted into the through-hole of the spring seat and the pull-out load on the fitting portion when it is pulled out of the through-hole of the spring seat depend on the force with which the fitting portion is deformed to a size at or below the size of through-hole of the spring seat. Accordingly, without any configuration to reduce the insertion load, lowering the insertion load for easier assembly of the elastic support member onto the spring seat undesirably leads to a lower pull-out load.

It is an object of the present invention to provide an elastic support member that can lower the insertion load without lowering the pull-out load.

### SUMMARY OF THE INVENTION

According to an aspect of the present invention, an elastic support member configured to be interposed between a spring and a spring support member configured to support an end of the spring is provided. The elastic support member includes a protrusion protruding from an opposing surface of the elastic support member facing the spring support member, the protrusion being configured to be inserted into a through-hole formed in the spring support member. The protrusion includes: a base sized, in a direction parallel to the opposing surface, to be smaller than a size of the through-hole and configured to be fitted in the through-hole; and a lug protruding outward from an outer periphery of the base, the lug being located opposite the opposing surface with respect to the spring support member when the base is fitted in the through-hole. The lug includes a recess between the lug and the base, the recess being depressed away from the opposing surface.

The present invention can lower the insertion load without lowering the pull-out load.

### BRIEF DESCRIPTION OF THE DRAWINGS

An exemplary embodiment of the present invention will be described in detail based on the following figures, wherein:

FIG. 1 illustrates an example schematic configuration of a suspension device;

FIG. 2 is a perspective view illustrating an example assembled state of a coil spring, a spring support member, and an elastic support member;

FIG. 3 is a perspective view illustrating an example pre-assembled state of the spring support member and the elastic support member;

FIG. 4 illustrates an example appearance of a protrusion as viewed in the radial direction;

FIG. 5 illustrates an example appearance of the protrusion as viewed in the direction of arrow V in FIG. 4;

FIG. 6 illustrates an example cross-section along line VI-VI in FIG. 4;

FIG. 7 illustrates an example cross-section along line VII-VII in FIG. 4;

FIG. 8 illustrates an example cross-section along line VIII-VIII in FIG. 4;

FIG. 9 illustrates an example cross-section along line IX-IX in FIG. 4;

FIG. 10 is an enlarged view of part X in FIG. 9;

FIG. 11 illustrates an example state of the protrusion after it is inserted in a through-hole of the spring support member; and

FIG. 12 illustrates an example state of the protrusion before it is pulled out of the through-hole of the spring support member.

### DETAILED DESCRIPTION OF THE INVENTION

An exemplary embodiment of the present invention is detailed below with reference to the appended drawings.

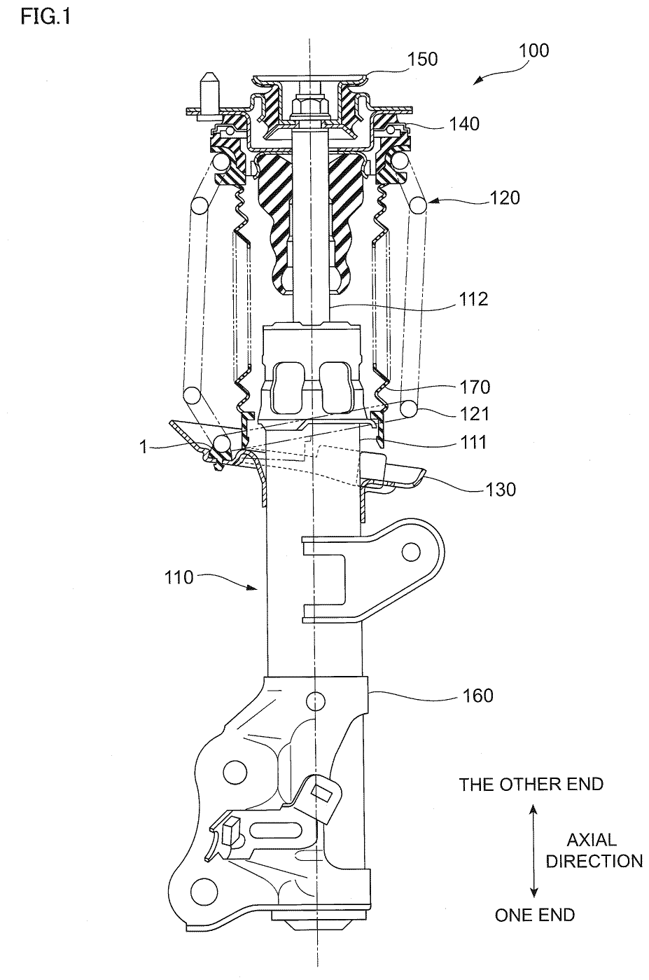

FIG. 1 illustrates an example schematic configuration of a suspension device 100.

The suspension device 100 is a suspension strut and, as shown in FIG. 1, includes a hydraulic shock absorber 110 and a coil spring 120 (an example of the spring) disposed outside the hydraulic shock absorber 110. The suspension device 100 further includes a spring support member 130 supporting one end (lower end in FIG. 1) of the coil spring 120 and a spring support member 140 supporting the other end (upper end in FIG. 1) of the coil spring 120. The suspension device 100 further includes an elastic support member 1 interposed between the coil spring 120 and the spring support member 130.

The suspension device 100 further includes a vehicle body-side bracket 150 and a wheel-side bracket 160. The vehicle body-side bracket 150 is attached to the other axial end of a piston rod 112 (described below) for attaching the suspension device 100 to the vehicle, and the wheel-side bracket 160 is secured to one axial end of a damper case 111 (described below) in the axial direction of the piston rod 112 for attaching the suspension device 100 to a wheel. The suspension device 100 further includes a dust cover 170 covering at least a portion of the piston rod 112.

The hydraulic shock absorber 110 includes a damper case 111 containing oil, a cylinder (not shown) coaxially disposed in the damper case 111, a piston (not shown) sliding within the cylinder, and a piston rod 112 holding the piston at one end and having the other end protruding from the damper case 111. The piston rod 112 is a columnar or cylindrical member.

The coil spring 120 is formed of a helically wound wire 121. The elastic support member 1 is attached to one end of the coil spring 120 over the length of about ⅗ arc. Hereinafter, the winding direction of the portion of the wire 121 of the coil spring 120 to which the elastic support member 1 is attached may be referred to simply as the “winding direction”. The radial direction of the helically wound wire 121 may be referred to simply as the “radial direction”.

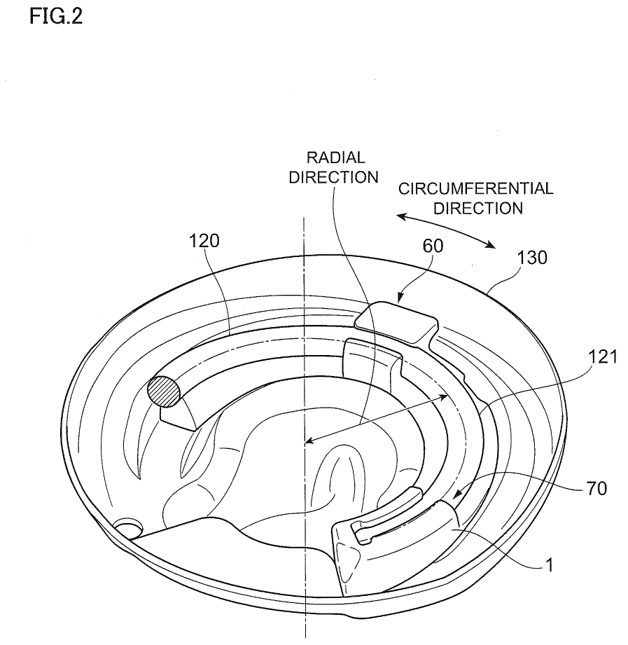

FIG. 2 is a perspective view illustrating an example assembled state of the coil spring 120, the spring support member 130, and the elastic support member 1.

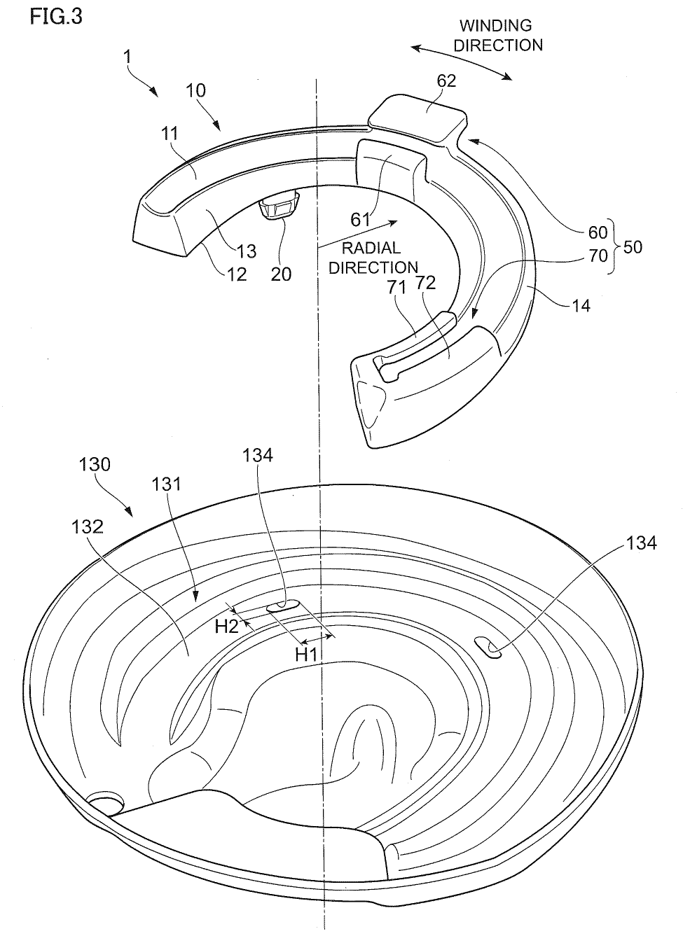

FIG. 3 is a perspective view illustrating an example pre-assembled state of the spring support member 130 and the elastic support member 1.

The spring support member 130 is a member secured to the damper case 111 (see FIG. 1) to support one end of the coil spring 120. By way of example, the spring support member 130 is formed by pressing a thin sheet of metal such as a steel plate.

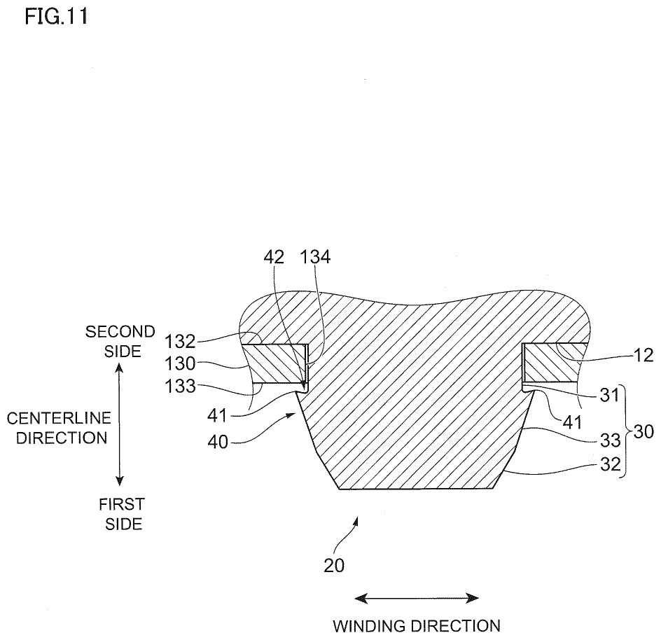

The spring support member 130 is formed with a groove 131 in which the elastic support member 1 is disposed. The groove 131 includes a placing surface 132 on which the elastic support member 1 is placed. The surface opposite the placing surface 132 is hereinafter referred to as a back surface 133 (see FIG. 11). The spring support member 130 is formed with through-holes 134 so as to provide communication between the placing surface 132 and the back surface 133. Two through-holes 134 are formed in the winding direction.

The elastic support member 1 is a rubber component interposed between the coil spring 120 and the spring support member 130. The elastic support member 1 reduces noise generation by mitigating impacts between the coil spring 120 and the spring support member 130.

The elastic support member 1 includes a seat 10 on which the coil spring 120 sits and a detachment preventing portion 50 that prevents the elastic support member 1 from being detached from the coil spring 120.

### (Seat 10)

The seat 10 includes a support surface 11 and an opposing surface 12. The support surface 11 is located adjacent to the coil spring 120 and supports the coil spring 120. The opposing surface 12 is located adjacent to the spring support member 130 and faces the placing surface 132 of the spring support member 130. The seat 10 also includes an inner side surface 13 facing radially inside and an outer side surface 14 facing radially outside.

The seat 10 also includes two protrusions 20 arranged along the winding direction and protruding from the opposing surface 12 toward the spring support member 130. The protrusions 20 will be detailed below.

As the protrusions 20 of the seat 10 are inserted into the respective through-holes 134 formed in the spring support member 130, the elastic support member 1 is positioned with respect to the spring support member 130 and also prevented from being detached from the spring support member 130.

### (Detachment Preventing Portion 50)

The detachment preventing portion 50 is a portion that prevents the elastic support member 1 from being detached from the coil spring 120 after the elastic support member 1 is attached to the coil spring 120. The detachment preventing portion 50 includes a first preventing portion 60 provided at the center of the elastic support member 1 in the winding direction and a second preventing portion 70 provided at an end of the elastic support member 1 in the winding direction.

As shown in FIG. 3, the first preventing portion 60 includes a first inner preventing piece 61 protruding radially inward and upward from the inner side surface 13 and extending radially outward so as to surround the wire 121. The first preventing portion 60 also includes a first outer preventing piece 62 protruding radially outward and upward from the outer side surface 14 and extending radially inward so as to surround the wire 121.

As shown in FIG. 3, the second preventing portion 70 includes a second inner preventing piece 71 protruding radially inward and upward from the inner side surface 13 and extends radially outward so as to surround the wire 121. The second preventing portion 70 also includes a second outer preventing piece 72 protruding radially outward and upward from the outer side surface 14 and extending radially inward so as to surround the wire 121.

### ((Protrusion 20))

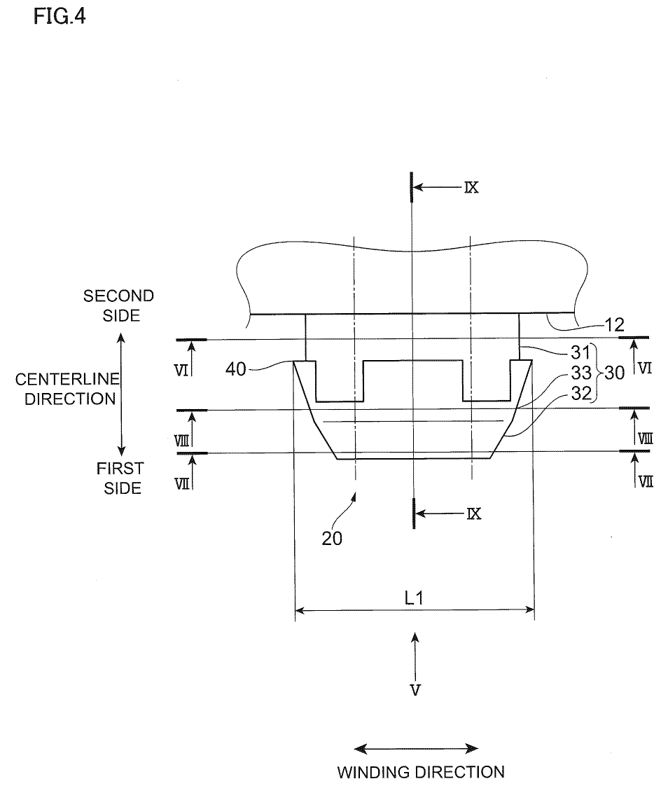

FIG. 4 illustrates an example appearance of the protrusion 20 as viewed in the radial direction.

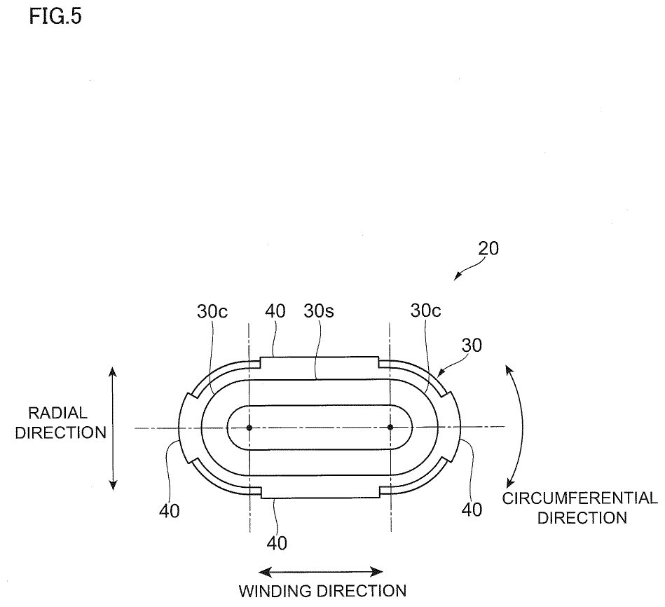

FIG. 5 illustrates an example appearance of the protrusion 20 as viewed in the direction of arrow V in FIG. 4.

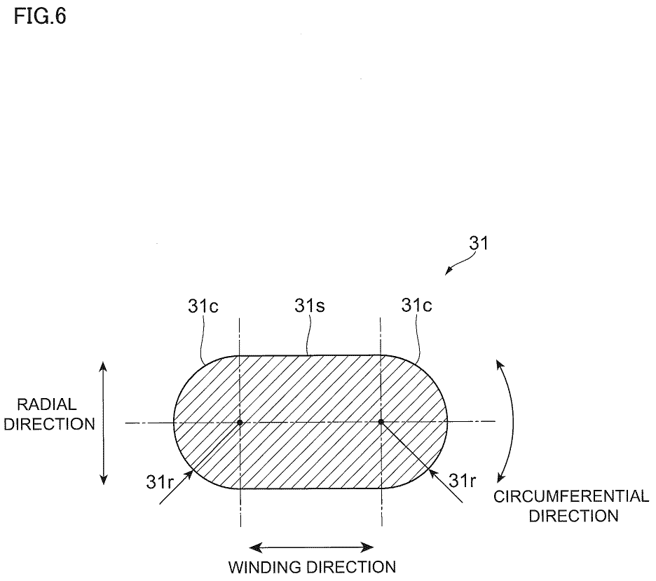

FIG. 6 illustrates an example cross-section along line VI-VI in FIG. 4.

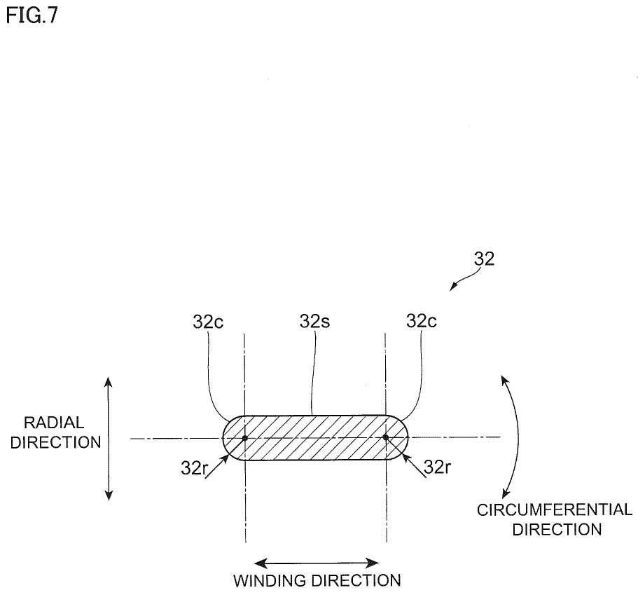

FIG. 7 illustrates an example cross-section along line VII-VII in FIG. 4.

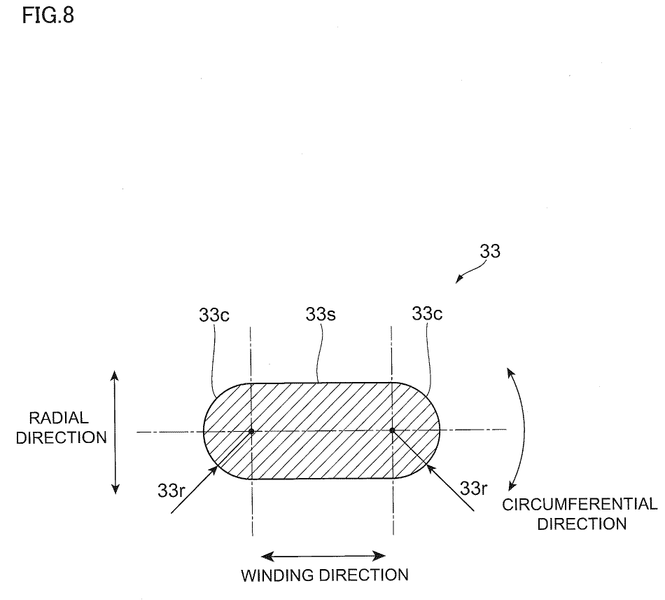

FIG. 8 illustrates an example cross-section along line VIII-VIII in FIG. 4.

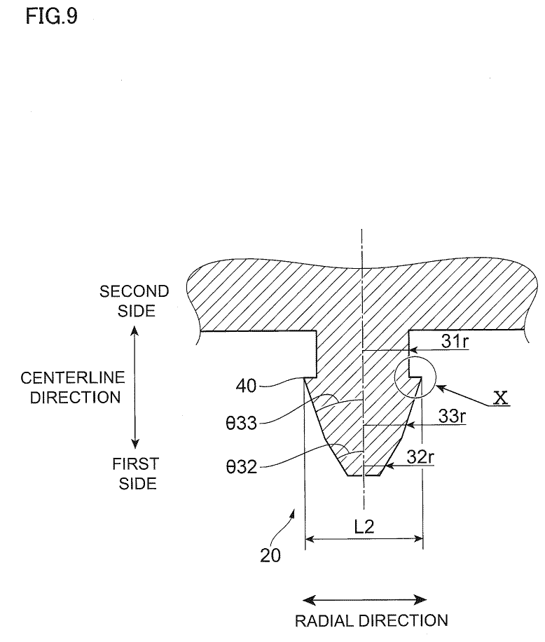

FIG. 9 illustrates an example cross-section along line IX-IX in FIG. 4.

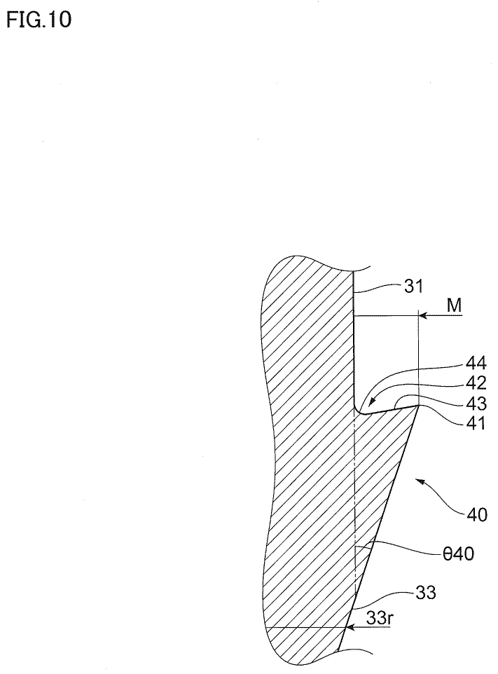

FIG. 10 is an enlarged view of part X in FIG. 9.

The protrusion 20 includes a base 30 of a columnar shape and lugs 40 protruding outward from the outer periphery of the base 30. The centerline direction of the base 30 may be referred to hereinafter simply as the “centerline direction.” In the centerline direction, the lower and upper sides in FIG. 4 may be referred to as the “first side” and “second side,” respectively.

### (((Base 30)))

The base 30 includes a proximal end 31 adjacent to the opposing surface 12 (on the second side), a distal end 32 farthest from the opposing surface 12, and an intermediate portion 33 between the proximal end 31 and the distal end 32.

As shown in FIG. 5, the shape of the base 30 as viewed in the centerline direction consists of two semicircles 30c divided from a true circle and a rectangle 30s of the same width as the diameter of the true circle (twice the radius of the semicircle 30c) in between (this shape may be referred to hereinafter as an “oblong”). The shape of the base 30 as viewed in the centerline direction is not limited to an oblong as in the present embodiment, and may be any other shape that is larger in the winding direction than in the radial direction. For example, the shape of the base 30 may be an ellipse, a rectangle with rounded corners, or a triangle.

For example, as shown in FIG. 6, the proximal end 31 has a shape that consists of two semicircles 31c divided from a true circle and a rectangle 31s of the same width as the diameter of the true circle (twice the radius 31r of the semicircle 31c) in between.

As shown in FIG. 7, the distal end 32 has a shape that consists of two semicircles 32c divided from a true circle and a rectangle 32s of the same width as the diameter of the true circle (twice the radius 32r of the semicircle 32c) in between.

As shown in FIG. 8, the intermediate portion 33 has a shape that consists of two semicircles 33c divided from a true circle and a rectangle 33s of the same width as the diameter of the true circle (twice the radius 33r of the semicircle 33c) in between.

As shown in FIG. 9, the radius 33r of the semicircle 33c of the intermediate portion 33 gradually decreases as one moves from the proximal end 31 toward the distal end 32. The radius 32r of the semicircle 32c of the distal end 32 gradually decreases as one moves away from the intermediate portion 33.

The amount of change in the radius 32r is greater than the amount of change in the radius 33r. In other words, an angle θ32 of the outer peripheral surface of the distal end 32 with respect to the centerline direction is greater than an angle θ33 of the outer peripheral surface of the intermediate portion 33 with respect to the centerline direction.

### (((Lug 40)))

As shown in FIGS. 9 and 10, the lugs 40 are portions protruding outward from the outer peripheral surface of the proximal end 31.

As shown in FIG. 5, there are four lugs 40 provided along the circumferential direction of the outer peripheral surface of the proximal end 31. More specifically, two lugs 40 are provided, one on each of the outer peripheral surfaces of the two semicircles 31c, and two lugs 40 are provided, one on each of the two longitudinal outer peripheral surfaces of the rectangle 31s.

The lugs 40 are provided at the first side portions of the proximal end 31. The outer peripheral surface of each lug 40 is continuous with the outer peripheral surface of the intermediate portion 33 and is inclined with respect to the centerline direction. The amount of change in protruding amount M of the outer peripheral surface of the lug 40 from the proximal end 31 is the same as the amount of change in the radius 33r of the semicircle 33c of the intermediate portion 33, so that an angle θ40 of the outer peripheral surface of the lug 40 with respect to the centerline direction is the same as the angle θ33 of the outer peripheral surface of the intermediate portion 33 with respect to the centerline direction.

Hence, as shown in FIG. 10, the outer periphery of the second side end of the lug 40 defines an outer edge 41 of the lug 40 that protrudes the most from the proximal end 31 in a direction parallel to the opposing surface 12.

The size L1 in the direction parallel to the opposing surface 12 between the outer edges 41 of the two lugs 40 mutually opposed in the winding direction, as shown in FIG. 4, is larger than the size H1 of the through-hole 134 (see FIG. 3).

The size L2 in the direction parallel to the opposing surface 12 between the outer edges 41 of the two lugs 40 mutually opposed in the radial direction, as shown in FIG. 9, is larger than the size H2 of the through-hole 134 (see FIG. 3).

Each lug 40 includes a recess 42 between the outer edge 41 and the proximal end 31. The recess 42 is depressed away from the opposing surface 12. The recess 42 includes an inclined surface 43 inclined from the outer edge 41 with respect to the opposing surface 12 and a curved surface 44 connecting the inclined surface 43 to the outer peripheral surface of the proximal end 31. The curved surface 44 facilitates elastic deformation of the outer edge 41 toward the proximal end 31.

FIG. 11 illustrates an example state of the protrusion 20 after it is inserted in the through-hole 134 of the spring support member 130.

The elastic support member 1 configured as described above has each protrusion 20 inserted into the corresponding through-hole 134 of the spring support member 130 while holding one end of the coil spring 120. More specifically, the protrusion 20 is inserted, starting with the distal end 32, into the corresponding through-hole 134. Then, the two lugs 40 mutually opposed in the winding direction and the two lugs 40 mutually opposed in the radial direction contact the edge of the through-hole 134. As the protrusion 20 is further inserted toward the first side, the outer edges 41 of the lugs 40 are elastically deformed toward the proximal end 31, and the lugs 40 pass through the through-hole 134 and toward the first side relative to the spring support member 130. Thus, as shown in FIG. 11, the portion of the proximal end 31 of the protrusion 20 on the second side relative to the lugs 40 fits in the through-hole 134. As a result, with the portion of the proximal end 31 of the protrusion 20 on the second side relative to the lugs 40 fitted in the through-hole 134, the lugs 40 are positioned on the first side relative to the back surface 133 of the spring support member 130.

When the lugs 40 pass through the through-hole 134, each outer edge 41 is easily elastically deformed toward the proximal end 31 because of the presence of the recess 42 between the outer edge 41 and the proximal end 31. This lowers the insertion load required for inserting the protrusion 20 into the through-hole 134 when attaching the elastic support member 1 to the spring support member 130, compared to a configuration in which the lug 40 does not have the recess 42.

The lugs 40 are not provided all around the periphery of the base 30, but are provided on portions of the periphery of the base 30. Thus, the elastic support member 1 requires a lower insertion load, compared to, for example, a configuration in which a portion protruding outward from the base 30 is provided all around the periphery of the base 30.

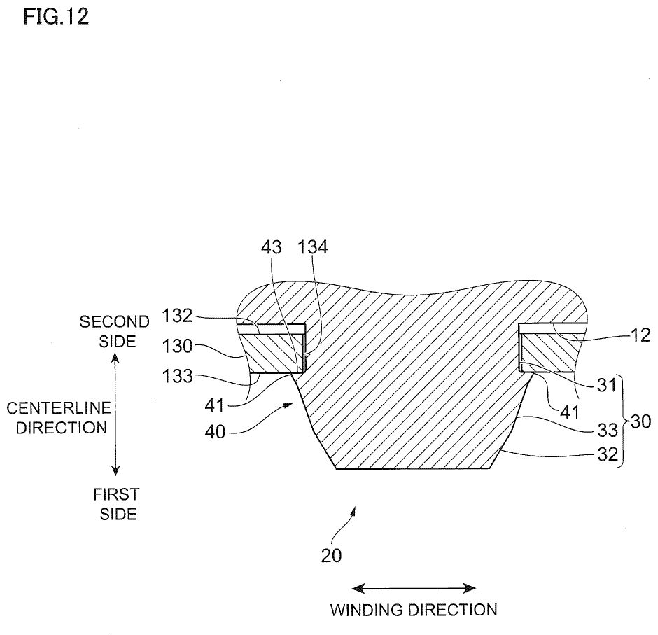

FIG. 12 illustrates an example state of the protrusion 20 before it is pulled out of the through-hole 134 of the spring support member 130.

The protrusion 20 is not easily pulled out of the through-hole 134 because the lugs 40 stick to the portions around the through-hole 134 in the back surface 133 of the spring support member 130. More specifically, the outer edge 41 contacts the back surface 133 of the spring support member 130 and then moves away from the proximal end 31, which causes the recess 42 to deform so as to move toward the second side. This leads to an increased area where the inclined surface 43 and the curved surface 44 contact the back surface 133 of the spring support member 130. As a result, this increases the pull-out load required for pulling the protrusion 20 out of the through-hole 134, compared to a configuration in which the lug 40 does not have the recess 42.

Of the four lugs 40, one pair of lugs 40 provided on the respective outer peripheral surfaces of the two semicircles 31c is provided on opposite sides of the base 30. In other words, one pair of lugs 40 is provided opposite each other across the base 30. Of the four lugs 40, the other pair of lugs 40 provided on the respective two longitudinal outer peripheral surfaces of the rectangle 31s is provided on opposite sides of the base 30. In other words, the other pair of lugs 40 is provided opposite each other across the base 30. This makes it more probable that the lugs 40 tend to stick to the back surface 133 of the spring support member 130 when the protrusion 20 is being pulled out of the through-hole 134. As a result, it is more probable that the elastic support member 1 requires a higher pull-out load.

As described above, the elastic support member 1 includes the protrusions 20 protruding from the opposing surface 12 facing the spring support member 130 and inserted into the respective through-holes 134 formed in the spring support member 130. Each protrusion 20 includes the base 30 fitted into the corresponding through-hole 134 and sized, in the direction parallel to the opposing surface 12, to be smaller than the size of the through-hole 134 in the direction parallel to the opposing surface 12. The protrusion 20 includes the lugs 40 protruding outward from the outer periphery of the base 30 and located opposite the opposing surface 12 with respect to the spring support member 130 when the base 30 is fitted in the through-hole 134. Each lug 40 includes the recess 42 between it and the base 30 depressed away from the opposing surface 12.

As mentioned earlier, the elastic support member 1 configured as described above allows the lugs 40 to be easily elastically deformed toward the base 30 when the lugs 40 pass through the through-hole 134, so that a lower insertion load is required for inserting the protrusion 20 into the through-hole 134. Additionally, the lugs 40 tend to stick to the spring support member 130 when the protrusion 20 is being pulled out of the through-hole 134, so that a higher pull-out load is required.

The lugs 40 are provided at multiple locations around the base 30. Thus, the area of contact between the lugs 40 and the edge of the through-hole 134 is smaller than, for example, when a lug 40 is formed around the entire periphery of the base 30. As a result, the elastic support member 1 requires a lower insertion load for inserting the protrusion 20 into the through-hole 134.

Two of the multiple lugs 40 of the elastic support member 1 are provided on opposite sides of the base 30, i.e., opposite each other across the base 30, and the size between the outer edges 41 of the two lugs 40 in the direction parallel to the opposing surface 12 is larger than the size of the through-hole 134 in the direction parallel to the opposing surface 12. This makes it more probable that the lugs 40 tend to stick to the back surface 133 of the spring support member 130 when the protrusion 20 is being pulled out of the through-hole 134, so that a higher pull-out load is required.

The cross-section of the base 30 in the direction parallel to the opposing surface 12 is of an oblong shape consisting of the two semicircles 30c divided from a true circle and the rectangle 30s with the same width as the diameter of the true circle in between. This can increase the size of the protrusion 20 and the through-hole 134 compared to, for example, when the base 30 and the through-hole 134 are in the form of a true circle.

As mentioned earlier, the shape of the protrusion 20 is not limited to an oblong, and may be any other shape that is larger in the winding direction than in the radial direction.

The size of the distal end 32 and the intermediate portion 33, which are examples of the portion of the base 30 farther from the opposing surface 12 than the lugs 40, in the depth direction of the through-hole 134, i.e., in the centerline direction, is larger than the size of the through-hole 134 itself in the depth direction.

This increases the amount by which the distal end 32 protrudes from the back surface 133 of the spring support member 130 toward the first side when the distal end 32 and the intermediate portion 33 of the protrusion 20 of the elastic support member 1 are inserted into the through-hole 134 for assembling the elastic support member 1 to the spring support member 130. This makes it easy to confirm that the elastic support member 1 is in the right position with respect to the spring support member 130 by checking this portion protruding from the back surface 133 toward the first side by hand or by means of a sensor or the like. As a result, the elastic support member 1 can be easily positioned with respect to the spring support member 130 when assembling the elastic support member 1 to the spring support member 130. Note that the shape of the base 30 and the through-hole 134 may be an ellipse with the minor axis extending in the radial direction.

The opposing surface 12 of the elastic support member 1 may be depressed at its radial center toward the second side before the elastic support member 1 is assembled to the coil spring 120 and the spring support member 130, and may become parallel to the placing surface 132 of the spring support member 130 upon contacting it when the elastic support member 1 is assembled to the coil spring 120 and the spring support member 130. That is, the direction parallel to the opposing surface 12 is, in other words, a direction parallel to the placing surface 132.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art without departing from the scope and spirit of the present invention. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An elastic support member configured to be interposed between a spring and a spring support member configured to support an end of the spring, the elastic support member comprising:
a protrusion protruding from an opposing surface of the elastic support member facing the spring support member, the protrusion being configured to be inserted into a through-hole formed in the spring support member, wherein
the protrusion comprises:
a base sized, in a direction parallel to the opposing surface, to be smaller than a size of the through-hole and configured to be fitted in the through-hole; and
a lug protruding outward from an outer periphery of the base, the lug being located opposite the opposing surface with respect to the spring support member when the base is fitted in the through-hole, and
the lug comprises a recess between the lug and the base, the recess being depressed away from the opposing surface.

2. The elastic support member according to claim 1, wherein the lug comprises a plurality of lugs provided around the base.

3. The elastic support member according to claim 2, wherein two of the plurality of lugs are provided on opposite sides to the base, and a size between outer edges of the two protrusions in a direction parallel to the opposing surface is larger than the size of the through-hole.

4. The elastic support member according to claim 1, wherein a cross-section of the base in a direction parallel to the opposing surface is larger in a winding direction of the spring than in a radial direction of the spring.

5. The elastic support member according to claim 1, wherein a portion of the base located farther from the opposing surface than the lug is sized, in a depth direction of the through-hole, to be larger than a size of the through-hole itself in the depth direction.

6. A suspension device comprising:
a spring;
a spring support member configured to support an end of the spring; and
the elastic support member of claim 1, the elastic support member being interposed between the spring and the spring support member.
